(19) United States
(12) Patent Application Publication
(10) Pub. No.: US 2022/0400918 A1
(43) Pub. Date: Dec. 22, 2022

(54) SEPARATION STRUCTURE FOR DUST CUP OF VACUUM CLEANER

(71) Applicant: Shenzhen Shermon Technology Co., Limited, Shenzhen (CN)

(72) Inventor: Pengfei Lu, Shenzhen (CN)

(21) Appl. No.: 17/566,619

(22) Filed: Dec. 30, 2021

Related U.S. Application Data
(63) Continuation of application No. PCT/CN2021/132320, filed on Nov. 23, 2021.

(30) Foreign Application Priority Data
Jun. 17, 2021 (CN) 202121353171.4

(51) Int. Cl. A47L 9/16; A47L 9/12; B01D 45/16; B01D 50/20; B01D 46/10; B04C 3/06; B04C 9/00; B04C 3/04

(52) U.S. Cl. CPC A47L 9/1608; A47L 9/165; A47L 9/122; A47L 9/1666; B01D 45/16; B01D 50/20; B01D 46/10; B04C 3/06; B04C 9/00; A47L 9/1641; B04C 3/04; B01D 2279/55; B04C 2009/002

(57) ABSTRACT

A separation structure for a dust cup of a vacuum cleaner is provided and includes a main body and a separator. The separator is fixedly mounted in an internal space of the main body. The internal space of the main body is divided by the separator into a first chamber, a second chamber and a third chamber. The separator is provided with a through hole, an air intake portion and a plurality of sedimentation portions communicated with the air intake portion. The plurality of sedimentation portions are arranged around the air intake portion. A length of the air intake portion is smaller than a length of each of the plurality of sedimentation portions. The air intake portion is communicated with the second chamber, the plurality of sedimentation portions are communicated with the third chamber. The first chamber is communicated with the second chamber via the through hole.

### CROSS-REFERENCE TO RELATED APPLICATIONS

The present application is a continuation-application of International Application PCT/CN2021/132320, with an international filing date of Nov. 23, 2021, which claims foreign priority of Chinese Patent Application No. 202121353171.4, filed on Jun. 17, 2021, the contents of all of which are hereby incorporated by reference.

### TECHNICAL FIELD

The present disclosure relates to relates to the technical field of vacuum cleaners, in particular to a separation structure for a dust cup of a vacuum cleaner.

### BACKGROUND

A dust cup is essential for a vacuum cleaner. When the vacuum cleaner operates, the mixture of air and waste is sucked into the dust cup by a motor-driven brush. After the waste is separated from the air by a separator in the dust cup, the waste is stored in the dust cup, and the air is discharged from an exhaust port of the motor. The separator in the dust cup may be of a single-cone type or a multi-cone type. The multi-cone separator has good separation effect and is popular with consumers. However, the existing dust cup with the multi-cone separator has the following disadvantages.

Firstly, the multi-cone separator has a complex structure and occupies a large space, so that the dust cup has a large size and requires to be driven by a high-power motor.

Secondly, a sedimentation cone and an intake tube of the multi-cone separator are independent components, which not only need to be produced separately, but also need to be manually assembled, resulting in increased production cost of the dust cup.

### SUMMARY

In order to solve the above problems, the present disclosure provides a separation structure for a dust cup of a vacuum cleaner.

The present disclosure is realized by the following technical schemes.

The present disclosure provides a separation structure for a dust cup of a vacuum cleaner. The separation structure includes a main body and a separator. The separator is fixedly mounted in an internal space of the main body. The internal space of the main body is divided by the separator into a first chamber, a second chamber and a third chamber. The separator is provided with a through hole, an air intake portion and a plurality of sedimentation portions communicated with the air intake portion. The plurality of sedimentation portions are arranged around the air intake portion. A length of the air intake portion is smaller than a length of each of the plurality of sedimentation portions. The air intake portion is communicated with the second chamber, the plurality of sedimentation portions are communicated with the third chamber. The first chamber is communicated with the second chamber via the through hole.

In an embodiment, a ratio of the length of each of the plurality of sedimentation portions to the length of the air intake portion is in a range of 1.5 to 2.5.

In an embodiment, the separation structure further includes a filter screen arranged along a periphery of the separator and covering the through hole.

In an embodiment, the separator is provided with a plurality of ventilation grooves, each of which corresponds to a respective one of the plurality of sedimentation portions. The plurality of sedimentation portions are communicated with the air intake portion through the plurality of ventilation grooves.

In an embodiment, each of the plurality of sedimentation portions includes a cylindrical tube and a conical tube communicated with the cylindrical tube. A length of the conical tube is greater than a length of the cylindrical tube. The conical tube is communicated with the third chamber, and the cylindrical tube is communicated with the air intake portion through a respective one of the plurality of ventilation grooves.

In an embodiment, the main body is further provided with a plurality of air outlet tubes, each of which corresponds to a respective one of the plurality of sedimentation portions and is received within the cylindrical tube.

In an embodiment, the separation structure further includes a filter cotton. A recess is defined by the main body to form a fourth chamber. The plurality of air outlet tubes are communicated with the fourth chamber. The filter cotton is received in the fourth chamber and covers the plurality of air outlet tubes.

In an embodiment, a distance from a center of the cylindrical tube to a center of the air intake portion is L, and a ratio of 2 L to a maximum inner diameter of the air intake portion is in a range of 1.8 to 2.5.

In an embodiment, a ratio of a maximum inner diameter of the air intake portion to a maximum width of each of the plurality of ventilation grooves is in a range of 4.5 to 5.5.

In an embodiment, the main body is further provided with an air inlet communicated with the first chamber.

The present disclosure has the following advantageous effects.

In the separation structure according to the present disclosure, the separator has a simple structure, the length of the air intake portion is short, a resistance of the air intake portion to the air flow is very small, and the mixture of air and waste can travel a short distance from the air intake portion to each sedimentation portion. The length of the separator is reduced, so that the size of the dust cup adopting the separation structure is reduced, and a low-power motor is sufficient for driving the dust cup.

### BRIEF DESCRIPTION OF THE DRAWINGS

In order to illustrate the technical solutions according to the embodiments of the present disclosure more clearly, the accompanying drawings for describing the embodiments are introduced briefly in the following. Apparently, the accompanying drawings in the following description are merely some embodiments of the present disclosure, and those skilled in the art may derive other drawings from the accompanying drawings without creative efforts.

FIG. 1 is a sectional view of a separation structure for a dust cup of a vacuum cleaner according to an embodiment of the present disclosure.

FIG. 2 is a sectional view of a main body of the separation structure according to an embodiment of the present disclosure.

FIG. 3 is a perspective view of a separator of the separation structure according to an embodiment of the present disclosure.

FIG. 4 is another perspective view of the separator of the separation structure according to an embodiment of the present disclosure.

### DETAILED DESCRIPTION

For clearer and complete description to the technical schemes of the present disclosure, the present disclosure is described further with reference to the accompanying drawings.

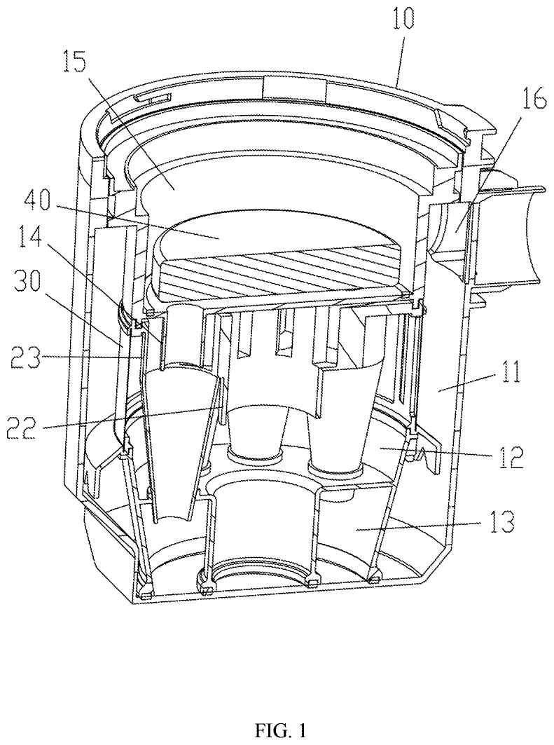

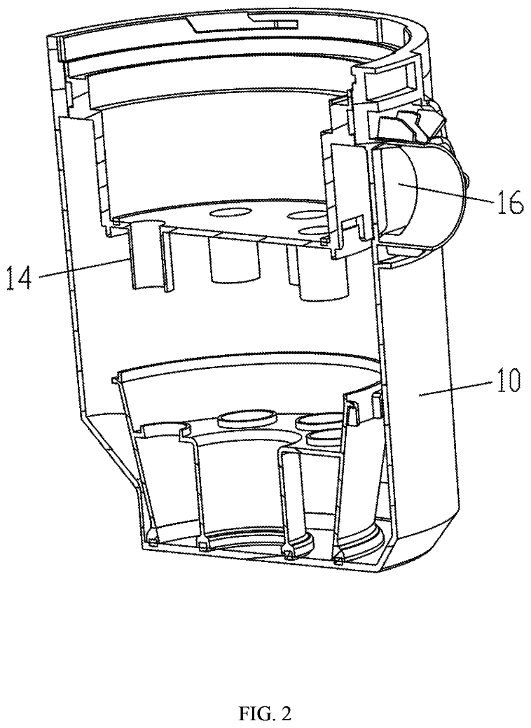

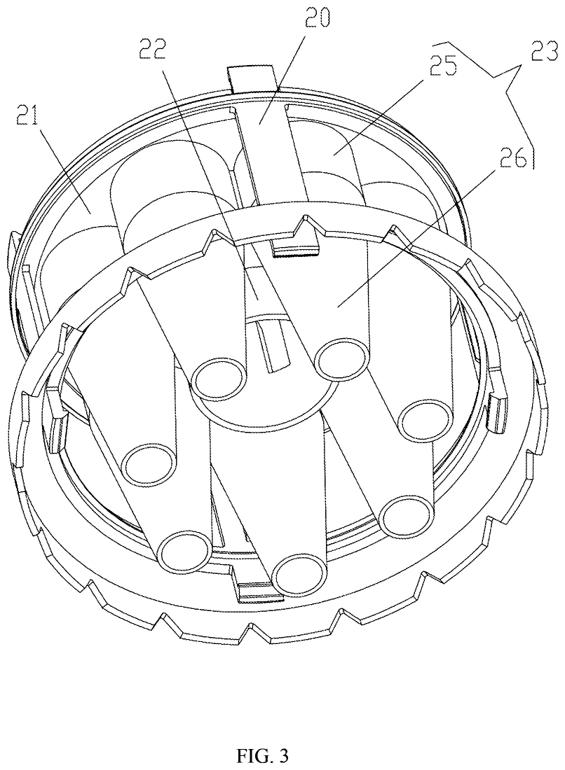

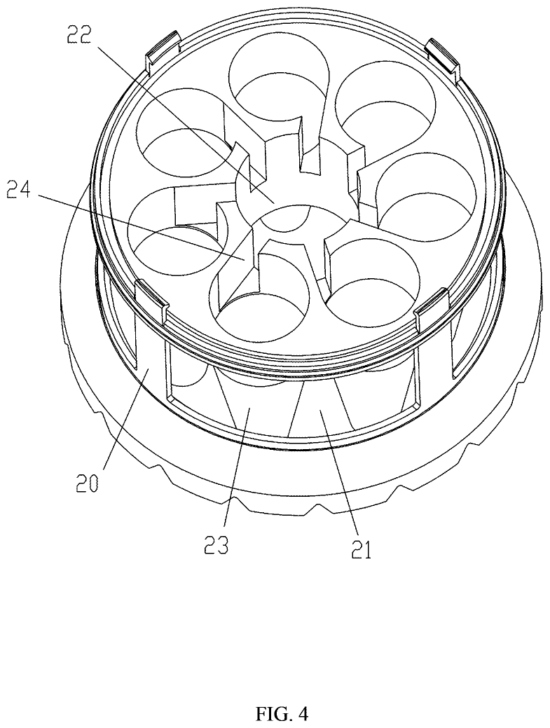

Referring to FIGS. 1 to 4, an embodiment of the present disclosure provides a separation structure for a dust cup of a vacuum cleaner. The separation structure includes a main body 10 and a separator 20. The separator 20 is fixedly mounted in an internal space of the main body 10. The internal space of the main body 10 is divided by the separator 20 into three chambers, i.e., a first chamber 11, a second chamber 12, and a third chamber 13. The separator 20 is provided with a through hole 21, an air intake portion 22, and a plurality of sedimentation portions 23 communicated with the air intake portion 22. The plurality of sedimentation portions 23 are arranged around the air intake portion 22. A length of the air intake portion 22 is smaller than a length of each sedimentation portion 23. The air intake portion 22 is communicated with the second chamber 12, the sedimentation portions 23 are communicated with the third chamber 13, and the first chamber 11 is communicated with the second chamber 12 via the through hole 21.

In this embodiment, the air intake portion 22 is a circular tube. The air intake portion 22 and the sedimentation portions 23 are both located within the second chamber 12.

In this embodiment, the separator 20 of the separation structure has a simple structure, the length of the air intake portion 22 is short, a resistance of the air intake portion 22 to the air flow is very small, and the mixture of air and waste can travel a short distance from the air intake portion 22 to each sedimentation portion 23. The length of the separator 20 is reduced, so that the size of the dust cup adopting the separation structure is reduced, and a low-power motor is sufficient for driving the dust cup.

In the present embodiment, the separator 20 is integrally formed without manual assembly, thereby reducing the production cost of the dust cup adopting the separation structure.

Further, a ratio of the length of each sedimentation portion 23 to the length of the air intake portion 22 is in a range of 1.5 to 2.5.

Further, the separation structure further includes a filter screen 30 arranged along a periphery of the separator 20. The filter screen 30 covers the through hole 21.

Further, the main body 10 also has an air inlet 16 communicated with the first chamber 11.

Further, the separator 20 is provided with a plurality of ventilation grooves 24, each of which corresponds to a respective sedimentation portions 23. The sedimentation portions 23 are communicated with the air intake portion 22 through the ventilation grooves 24.

Further, a ratio of a maximum inner diameter of the air intake portion 22 to a maximum width of each ventilation groove 24 is in a range of 4.5 to 5.5.

In this embodiment, when the dust cup adopting the separation structure is driven by a motor, the mixture of air and waste enters the first chamber 11 through the air inlet 16 and forms a rotating air flow, and a primary separation of the mixture of air and waste occurs with the filter 30. Large particles of the waste are prevented from entering the second chamber 12 by the filter 30, and gradually deposited at a bottom of the first chamber 11. The mixture of air and waste then enters the air intake portion 22 under the drive of the motor, and spirals up within the air intake portion 22 for a secondary separation, and a part of small particles of the waste is gradually deposited at a bottom of the second chamber 12. The mixture of air and waste then enters the sedimentation portions 23 through the ventilation grooves 24 under the drive of the motor, and by this time, the air flow formed by the mixture of air and waste has a higher rotating speed for a tertiary separation. Another part of the small particles of the waste is gradually deposited at a bottom of the third chamber 13 through the sedimentation portions 23, and by this time, most of the waste has been separated from the air.

In this embodiment, the air inlet 16 is provided on a side surface of the main body 10, and a flow path of the mixture of air and waste from the air inlet 16 to each sedimentation portion 23 can be shortened.

Further, each sedimentation portion 23 includes a cylindrical tube 25 and a conical tube 26 communicated with the cylindrical tube 25. A length of the conical tube 26 is greater than a length of the cylindrical tube 25. The conical tube 26 is communicated with the third chamber 13, and the cylindrical tube 25 is communicated with the air intake portion 22 through a respective ventilation groove 24.

Further, a distance from a center of the cylindrical tube 25 to a center of the air intake portion 22 is L, and a ratio of 2 L to the maximum inner diameter of the air intake portion 22 is in a range of 1.8 to 2.5.

In this embodiment, when the dust cup adopting the separation structure is driven by a motor, the mixture of air and waste enters the first chamber 11 through the air inlet 16 and forms a rotating air flow, and a primary separation of the mixture of air and waste occurs with the filter 30. Large particles of the waste are prevented from entering the second chamber 12 by the filter 30, and gradually deposited at a bottom of the first chamber 11. The mixture of air and waste then enters the air intake portion 22 under the drive of the motor, and spirals up within the air intake portion 22 for a secondary separation, and a part of small particles of the waste is gradually deposited at a bottom of the second chamber 12. The mixture of air and waste then enters the cylindrical tubes 25 through the ventilation grooves 24 under the drive of the motor, and by this time, the air flow formed by the mixture of air and waste has a higher rotating speed for a tertiary separation. Another part of the small particles of the waste is gradually deposited at a bottom of the third chamber 13 through the conical tubes 26, and by this time, most of the waste has been separated from the air.

Further, the main body 10 is provided with a plurality of air outlet tubes 14 each of which corresponds to a respective sedimentation portion 23. Each air outlet tube 14 is received within a respect cylindrical tube 25.

Further, the separation structure further includes a filter cotton 40. A recess is defined by the main body 10 to form a fourth chamber 15. The air outlet tubes 14 are communicated with the fourth chamber 15. The filter cotton 40 is received in the fourth chamber 15 and covers the air outlet tubes 14.

In this embodiment, when the dust cup adopting the separation structure is driven by a motor, the mixture of air and waste enters the first chamber 11 through the air inlet 16 and forms a rotating air flow, and a primary separation of the mixture of air and waste occurs with the filter 30. Large particles of the waste are prevented from entering the second chamber 12 by the filter 30, and gradually deposited at a bottom of the first chamber 11. The mixture of air and waste then enters the air intake portion 22 under the drive of the motor, and spirals up within the air intake portion 22 for a secondary separation, and a part of small particles of the waste is gradually deposited at a bottom of the second chamber 12. The mixture of air and waste then enters the cylindrical tubes 25 through the ventilation grooves 24 under the drive of the motor, and by this time, the air flow formed by the mixture of air and waste has a higher rotating speed for a tertiary separation. Another part of the small particles of the waste is gradually deposited at a bottom of the third chamber 13 through the conical tubes 26. The mixture of air and waste then enters the fourth chamber 15 through the air outlet tubes 14 with driving of the motor, and the waste is finally separated from the air through the filter cotton 40. The remaining small particles of the waste are adsorbed by the filter cotton 40, thereby achieving complete separation of the waste from the air.

It should be appreciated that the present disclosure may have various embodiments, and other embodiments obtained by those skilled in the art based on the embodiment in the present description without any creative effort fall within the protection scope of the present disclosure.

What is claimed is:

1. A separation structure for a dust cup of a vacuum cleaner, wherein the separation structure comprises a main body and a separator, the separator is fixedly mounted in an internal space of the main body, the internal space of the main body is divided by the separator into a first chamber, a second chamber and a third chamber, the separator is provided with a through hole, an air intake portion and a plurality of sedimentation portions communicated with the air intake portion, the plurality of sedimentation portions are arranged around the air intake portion, a length of the air intake portion is smaller than a length of each of the plurality of sedimentation portions, the air intake portion is communicated with the second chamber, the plurality of sedimentation portions are communicated with the third chamber, and the first chamber is communicated with the second chamber via the through hole.

2. The separation structure according to claim 1, wherein a ratio of the length of each of the plurality of sedimentation portions to the length of the air intake portion is in a range of 1.5 to 2.5.

3. The separation structure according to claim 1, further comprising a filter screen arranged along a periphery of the separator and covering the through hole.

4. The separation structure according to claim 1, wherein the separator is provided with a plurality of ventilation grooves, each of which corresponds to a respective one of the plurality of sedimentation portions, and the plurality of sedimentation portions are communicated with the air intake portion through the plurality of ventilation grooves.

5. The separation structure according to claim 4, wherein each of the plurality of sedimentation portions comprises a cylindrical tube and a conical tube communicated with the cylindrical tube, a length of the conical tube is greater than a length of the cylindrical tube, the conical tube is communicated with the third chamber, and the cylindrical tube is communicated with the air intake portion through a respective one of the plurality of ventilation grooves.

6. The separation structure according to claim 5, wherein the main body is further provided with a plurality of air outlet tubes, each of which corresponds to a respective one of the plurality of sedimentation portions and is received within the cylindrical tube.

7. The separation structure according to claim 6, further comprising a filter cotton, a recess is defined by the main body to form a fourth chamber, the plurality of air outlet tubes are communicated with the fourth chamber, and the filter cotton is received in the fourth chamber and covers the plurality of air outlet tubes.

8. The separation structure according to claim 5, wherein a distance from a center of the cylindrical tube to a center of the air intake portion is L, and a ratio of 2 L to a maximum inner diameter of the air intake portion is in a range of 1.8 to 2.5.

9. The separation structure according to claim 5, wherein a ratio of a maximum inner diameter of the air intake portion to a maximum width of each of the plurality of ventilation grooves is in a range of 4.5 to 5.5.

10. The separation structure according to claim 1, wherein the main body is further provided with an air inlet communicated with the first chamber.
